(19) United States
(12) Patent Application Publication
(10) Pub. No.: US 2002/0062300 A1
(43) Pub. Date: May 23, 2002

(54) Internet knowledge network using agents

(76) Inventors: Vadim Asadov, Moscow (RU); Sergey Shumsky, Troitsk (RU)

Correspondence Address: Christopher B. Kilner, Esq., Roberts Abokhair & Mardula, LLC, Suite 1000, 11800 Sunrise Valley Drive, Reston, VA, 20191-5302, US

(21) Appl. No.: 09/818,038

(22) Filed: Mar. 27, 2001

Related U.S. Application Data
(60) Provisional application No. 60/249,205, filed on Nov. 16, 2000.
(60) Provisional application No. 60/192,235, filed on Mar. 27, 2000.

(51) Int. Cl. G06F 7/00

(52) U.S. Cl. 707/1

(57) ABSTRACT

An electronic agent for a user including a server member for providing information concerning the user, the server member including an FTP server to provide information, a web server to provide access to information of the user and an Internet semantic server for indexing new information and providing responses to queries of clients. The electronic agent also includes a categorizer for creating hierarchic semantic space and crawler members for performing directed information searches. The crawler members arrange results of the directed information searches and deliver the arranged results of the directed information searches to users. A network system for exchanging information that includes providing a plurality of neurocomputers as agents associated with users, linking the plurality of agents, accumulating knowledge by each agent according to preferences by the user associated with the agent, and exchanging monetary value between the plurality of agents for answering queries and referring queries.

### RELATED APPLICATIONS

This application claims priority to U.S. Provisional Application Ser. Nos. 60/249,205, filed Nov. 16, 2000 and 60/192,235, filed Mar. 27, 2000, both of which are incorporated herein by reference.

### FIELD OF THE INVENTION

The present invention pertains to computer networks and more particularly to computer networks that are capable of learning to form a Knowledge network on the Internet using agents.

### BACKGROUND

Computer “thinking” is radically different from that of a human being. Computers are programmed externally, obediently performing the algorithms built into their memory. Human beings, however, are not programmed. They learn from examples. The brain is an active memory distributed among the neural network of ten billion neurons. The plasticity of links between these neurons provides the brain with an ability of memorizing and learning. Hence, the brain is equipped with a most valuable quality of self-programming. Even though the number of bytes recorded on an ordinary PC disk can exceed the number of brain neurons, human beings are capable of handling the tasks that are still undoable for the most powerful super-computers.

Such tasks include, for example, pattern recognition tasks. These types of tasks can make it difficult, and often impossible, to write the formal algorithms of their solution. As for the human beings, they are able to tell the people they know from one another, differentiate between the beauty and ugliness, and react correctly in complex situations. It is the human ability to recognize patterns that neurocomputing undertakes to reproduce in the computers of the new generation.

Neurocomputers or the neurocomputing software model uses the formation of associative links in an artificial neural network consisting of simplified formal neurons. The strength of links between these neurons changes in the process of learning from examples, i.e., which decision should be taken by a neural network in one situation or another situation. As a result the same neural network can prove to be capable of solving a wide range of tasks depending on what it has learned. It is able to learn and re-learn in real time through analyzing data flows.

The capabilities of a neural networks are much wider than just solving pattern recognition tasks. Neural networks are an ideal means for the extraction of knowledge from large data masses. Hence, in the situation of the identification of semantic categories, neural networks learn on the basis of the document masses, where the words are used in a particular context rather than optionally. The neural network is capable of learning to differentiate between these contexts and classify the words depending on their affiliation with different semantic categories. It can be assumed that the larger the database, the more useful the neural network is for its analysis and conversion into the database. Being the largest database, the Internet is an ideal environment for the application of neural networks. It is for this very reason that neural networks are considered as the basic technology for the agentware of the future.

The distinguishing feature of neural networks is global links between the basic elements, formal neurons. Normally, each neural network neuron is linked to all the neurons of the preceding layer of data processing. The links become specialized at the adjustment stage, learning on the basis of particular data. As they learn, an algorithm of the specific task develops like a photograph in the developer.

Each formal neuron does the simplest operation—it weighs the values of its inputs using the locally stored synaptic weights and performs a non-linear transformation of the value sum:

[chemical structure]

The fact that the neurons react only to the local information coming from their neighbors makes it possible to make the neural network algorithms parallel using special hardware. Adaptation of the neural network also has a local nature: each neuron changes its “adjustment parameters” (synaptic weights) depending on the incoming local information about the error of the network as a whole. This information is identified based on the network outputs (for example, “correct—incorrect”) and spreads over the network from the outputs to the inputs passing through each neuron on the way. Therefore, the basic algorithm of the network adaptation is called the “error back-propagation”. The error passes through the same synaptic links between the neurons and the strongest error signal is received by those neurons that contributed most to the erroneous response. As a result, the least adapted neurons are the fastest to learn. This is a very simple and effective learning principle—“everyone will be requited according to his deeds”. This is how biological neural networks developed such efficient algorithms for sensory information processing in the adaptation process.

The four most attractive features of this type of the information processing found in artificial neural networks are as follows.

First, the ability to solve informal tasks by independently developing complex algorithms of data processing that often cannot be formalized even by the best experts. This is one reason why neural network developments are relatively cheap.

Second, minimization of empirical error by means of back-propagation over the network is a single and effective principle of adaptation. Only the purpose of adaptation is set from the outside. Then the network gradually modifies its configuration minimizing its error, i.e. handling the task better and better.

Third, parallelism of information processing can form global links between the neurons. Before adaptation, these links are optional and usually weak. Example-based adaptation “develops” a specific network structure tailoring it to a specific task.

The fourth attractive feature is in reliability of functioning. Excessive links result in the fact that the values of each weight taken separately do not play a decisive role. Failure of the limited number of neurons or disruption of some links has no critical effect on the quality of operation of the whole network.

Unexplored space of the Internet opens up before Internet users who enter its territory. What is it that the user sees in this terra incognita? Traditional search engines are unsuccessful in trying to index the Internet by sending their robots in all directions. The world of free users in the free democratic Internet is followed by the world of autocratic large sites and user mobs who are incapable of showing creativity and taking advantage of the Internet as a new information environment. Actually, people are not making use of one of the Internet's core properties—its distributed character. A font of knowledge is slowly but surely turning into a refuse dump of information. Centralized sites are incapable of satisfying the individual needs of the users. While trying to embrace everything, they omit the specifics of particular subjects and issues that are so important to the individual users. As a result, many consulting agencies have began to mark the tendency of user's to drift from the centralized sites to the specialized ones.

Strong traffic centralization in the Internet automatically concentrates information about user's likes and habits into a few hands. Such centralization has generated and will generate privacy-related scandals about information leaks or its unauthorized use. These problems cannot be resolved even by systems designed for 100% ad coverage and targeting marketing because they still need information about the user's preferences. At the same time, many advertisers are complaining about the low effectiveness of banner ads used on the Internet. The conflict between the content of the reviewed page and the content of banners displayed with that content should be resolved by new methods.

Additionally, traditional Web portals suffer from other problems. They can lack scalability due to staff and hardware bottlenecks, they generally suffer from out of date indexes, and their news is usually of the general interest variety. Most of these “dot.coms” lack profitability because they use an outdated media model—broadcasting—for the new media of the Internet. Also, many portal users are becoming more concerned about their privacy and are becoming more and more reluctant to use the centralized personalization tools used by most portals.

These problems have led to the rise of distributed services such as Napster, Freenet, and Gnutella. These services offer the advantages of: full use of hardware (10⁸ Personal computers×10⁸ flops˜10¹⁶ flops); instant indexing; high personalization; and privacy through locally stored profiles. However, these services lack an adequate business model.

In the area of searching, present command line and Windows-style interfaces are limited to user-initiated or user-specified inputs based on hyperlinks and dialog boxes, and are therefore non-adaptive.

### SUMMARY OF THE INVENTION

The present invention solves the problems of the existing systems described above by providing a peer-to-peer knowledge network with a business model based on distributed money flow. By using intelligent search agents (i.e., self-learning neural agents or “electronic agents”), the system can be self-learning and proactive by acting on behalf of users and adapting to their preferences.

A distributed community of self-learning neural agents can learn twenty-four hours a day, seven days a weeks, three hundred sixty-five days a year. It can share knowledge and understand semantics and uses a currency-based protocol having intrinsic economic transactions that naturally limits query expansion and is self-organizing.

Based upon accumulated knowledge and technology, each user can offer the world his services and products without the brokers and intermediary structures. With corporate sites and Internet-services available, the user is able to create new pieces of information by gathering the existing information, processing and analyzing it. Eventually, this small contribution to the “added value” of information will turn beneficial for the user himself. Becoming united, such independent users and their groups create a Knowledge network above the information content. Unlike the information content, the Knowledge network is self-developing and self-structuring due to the joint work of a large number of users.

If the servers and trunks make the first Net level, the second level being the software and content, the present invention creates the third level—the Knowledge level—with the participation of all the Network users. The present invention seeks to make the Net information-independent by way of demonopolizing the information content. This Knowledge network is a network of interrelated adaptive cells (agents). The agents are able to understand the meaning of the information, adapt themselves while operating on it, and transmit it to each other in the interaction process.

The network activity transferred to the user's level due to the utilization of personal agents makes the system user-friendly. For the first time, agent personalization allows for the condition of mass creation of individual products and services directed at certain users interests and likes while keeping them confidential.

Implementation of the present invention is based on the idea of agentware application to individual users. Each network user is capable of bringing up his own agent(s) using simple interfaces and operation rules. The adapted agent(s) undertake(s) to do the largest part of the user's job in the Net.

Creation of such a Knowledge network can also change the structure of economic interaction in the Internet. Knowledge will be a universal value in this new economy. Primary information from the content-providers should be chargeable. Then the cost of knowledge will consist of the cost of the primary information and processing cost. The quality of both components will determine the total cost of knowledge. In this case, money becomes a real measure of the knowledge value. Natural price selection will separate the reviews of skilled lawyers from the term papers of first-year university students, a professional sports commentator from a schoolboy who is a fan of the local baseball team. Money will serve as an indicator of the people's mistakes, channeling their work towards the knowledge demanded by the market.

Transition to the payment of knowledge as the individual user-processed information leads to the transition from the economy of ad income gained by the centralized sites to the real earnings of a large number of users engaged in the Internet information processing. This economy is backed up by the micro-payment systems actively promoted today to the market of electronic transactions.

The fact that many users operate the agents forming the Knowledge network automatically removes a number of existing problems. For example, the procedure of creating centralized search indexs will be replaced by self-indexing of Internet by many users, operating on the principal that “every little bit helps.”

Each user becomes a carrier of his own ad billboards which contents are available only to him. He can transfer the ads to and receive them from others. However, the current state of the user's “ad space” remains available only to him. This approach ensures the required level of privacy of the user's habits and likes. On the other hand, this system allows for distribution of ads only to people who are interested in it, acting through each user who visits an “e-shop.”

The use of agents is based on several key technologies. First, the use is based on the present inventor's technology of semantic hierarchic indexing of information (documents), available from NeurOK LLC of Arlington, Va. Second, the use is based on visualization bot technology, like Bonzi, available form Bonzi.com. Third, the use is based on money and a peer-to-peer exchange technology (like Mondex).

In the Knowledge network, the standard agent includes a crawler member that performs the directed search of information on the Internet, its ranging and delivery to the user. It also includes a categorizer that creates the hierarchic semantic space on the basis of bookmark collection or documents, extracting the sense of terms during the information gathering and analyzing is included. An Internet semantic server generates an index of new information in the semantic space and provides responses to the queries of the client part. A storage unit, with a client interface, is provided to store information delivered by the crawlers and inserted by the user. A web server provides access to the user's information on the basis of hyperlinks. An FTP server provides access to the user's information on the basis of TCP/IP protocol.

### DESCRIPTION OF THE DRAWINGS

FIG. 1 is a diagram illustrating the structure of a neuroagent.

FIG. 2 is a diagram illustrating the growth process of the neuroagent of FIG. 1.

FIG. 3 is a diagram illustrating the interaction between neuroagents such as those illustrated in FIG. 1.

FIG. 4 is a diagram illustrating the interaction of neuroagents in an Advertising environment.

FIG. 5 is a diagram illustrating hierarchic categorization of semantic space.

FIG. 6 is a diagram illustrating the flow of hierarchic searches.

FIG. 7 is a diagram illustrating hierarchic filtering in semantic space.

FIG. 8 is a diagram illustrating hierarchic visualization.

FIG. 9 is a diagram illustrating the operation of search agents.

FIG. 10 is a diagram illustrating the cross-pollination of information among agents.

FIG. 11 is a diagram illustrating the selection process of agents.

FIG. 12 is a diagram illustrating the function of the economics of the Knowledge network.

FIG. 13 is a diagram of the entrance point of a user into the Knowledge network.

FIG. 14 is a diagram illustrating the functioning of currency based protocol in the Knowledge network.

FIG. 15 is a diagram illustrating the operation of advertising and advertising banners in the Knowledge network.

FIG. 16 is a diagram illustrating the effect of advertising banners and their use as coupons in the Knowledge network.

FIG. 17 is a diagram illustrating the business model operating in the Knowledge network.

FIG. 18 is a chart illustrating a proposed currency exchange model for use in the Knowledge network.

### DETAILED DESCRIPTION OF THE PREFERRED EMBODIMENT

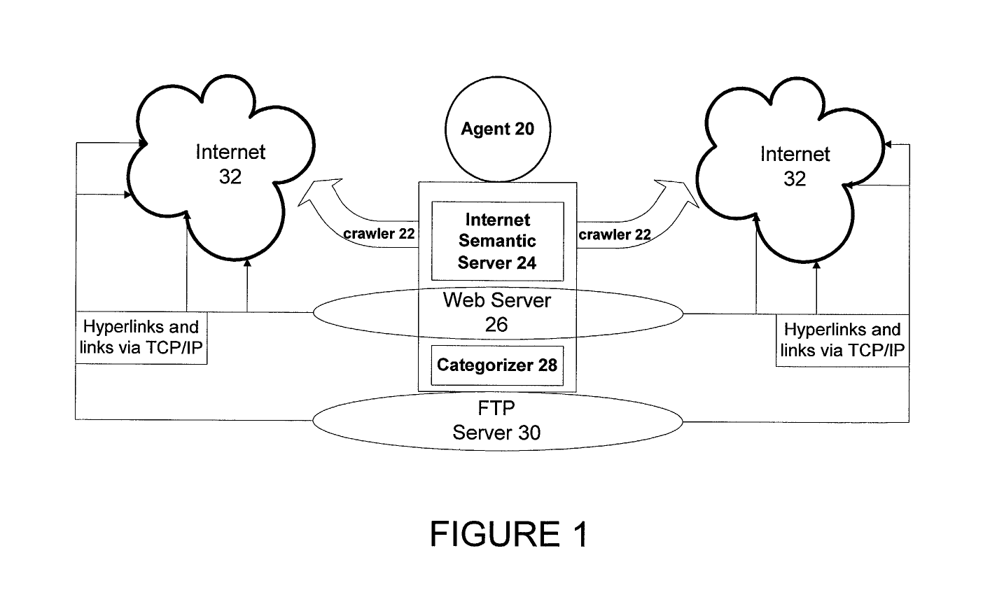

The structure of an agent 20 and the interaction of its parts, crawler members 22, Internet semantic server 24, web server 26, categorizer 28 and FTP server 30 are shown in FIG. 1. Crawler members 22 perform the directed search of information on the Internet 32, its ranging and delivery to the user. Categorizer 28 creates the hierarchic semantic space on the basis of bookmark collection or documents, extracting the sense of terms during the information gathering and analyzing is included. Internet semantic server 24 generates an index of new information in the semantic space and provides responses to the queries of the client part. A storage unit with client interface is provided to store information delivered by crawler members 22 and inserted by the user. Web server 26 provides access to the user's information on the basis of hyperlinks. FTP server 30 provides access to the user's information on the basis of TCP/IP protocol.

Agent 20 operates as follows. The user downloads software for agent 20 from NeurOK's site. Agent 20 can be “raw”, non-adapted or adapted by someone. In case agent 20 is non-adapted, the user starts the adaptation process. During this process agent 20, using available crawler members 22, collects from Internet 32 the information, documentation, which is of interest to the user. Agent 20 can start from zero or use the accumulated bookmarks for the selection of the subjects of the information to be collected. During the collection process the user can express his attitude to one document or another on the basis of “interesting—not interesting, good—bad” principle. Agent 20 understands the user's attitude and adjusts the process of gathering and forming of the document collection.

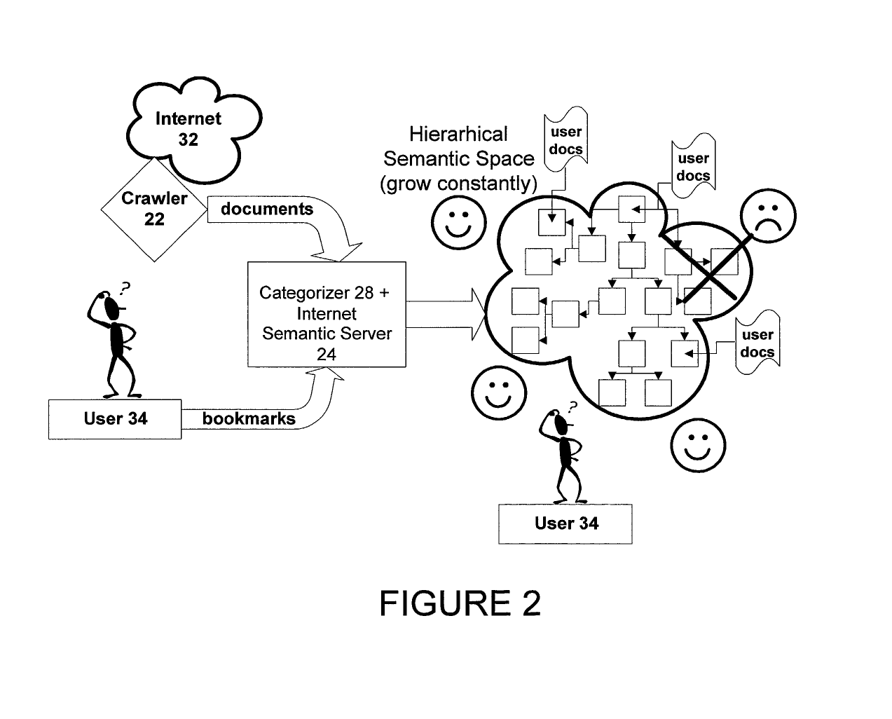

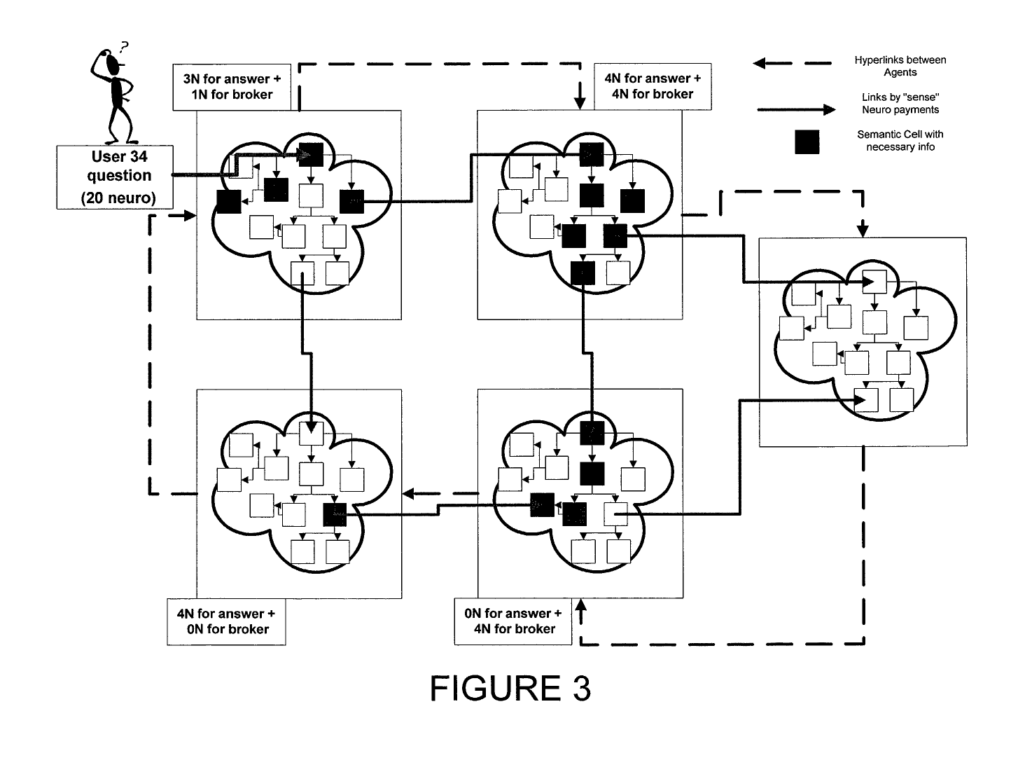

The processes of adaptation and work of agent 20 are shown in FIG. 2. The collection is hierarchically indexed by means of categorizer 28 on the basis of NeurOK's technology, such as their “Semantic Explorer” product. The documents are presented as a hierarchic structure of semantic spaces, as shown in FIG. 3. The theme of semantic space goes narrow depending of the deepness of hierarchy. Within the semantic spaces, the documents are ranged according to the number of incoming and outgoing references (this technology is similar to Clever technology by IBM). The produced adapted agent 20 constitutes a description of the interests of user 34 and presents his knowledge in the network. It also includes the musical tastes of user 34 in the form of MP3 file library. These sets of different users are connected via ftp-server 30. In the future, the special mechanisms will be added to agent 20 for work with graphics and video information.

Like a document, the contents of each agent 20 and ad banner can be loaded into the semantic space of each additional agent 20. That is why, finally, each agent 20 will have the content of each document, ad banner and other connected agent and a rating of each document, ad banner and other connected agent.

By means of web-server 26 and ftp-server 30, built-in mechanisms, agent 20 is delivered to Internet 32 and contacts other agents 20 via hyperlinks. The increased number of agents results in a huge agent network—a Knowledge network—containing the knowledge of individual users 34. As each agent indexes a small part of Internet 32 related to the individual user's 34 interest, there occurs a gradual distributed indexing of all the Internet 32 with the indexing rate having the same order as the Internet growth rate.

One should note that the semantic space of a particular agent 20 is separable. One user 34 can take from another one only a part of another user's 34 agent 20 and, based on that part, cultivate his own agent adjusted to his personal interests. As an example, user 34, who is interested in baseball, can take only a baseball part from any sport observer agent 20. Follow this; the fan of “NY Yankees” can cultivate his agent 20 based on part of the baseball agent and so on.

The adapted agent 20 and, de facto, Knowledge network can be asked any question by user 34. The preparation of replies to those answers is based on the economic relationships between the agents. The present invention introduces a “neuro”, a special monetary unit for the payment of agent 20 services, sale and purchase and lease of agents 20 and other economic relations in the world of agent 20. Agent 20 can receive money either for a reply to the question or for the indication of a location where the reply is available. In the first case it retains all the money while in the second case it only gets a commission. Agent 20 tries to maximize total earnings maintaining the quality of Knowledge delivered at the level set by the user. The number of “neuro” will serve as a measure of the agent 20 efficiency and “intelligence”. The total number of “neuro” in the system is a general measure of the Network “intelligence” and Internet IQ.

Hence, growth and operation of the Knowledge network is effectively equivalent to the Internet “self-investigation”, genesis of the elements of Intelligence. Such growth process is controlled naturally due to the competition and cooperation between agents 20. The “natural” selection leaves only the strongest (the most useful and necessary) alive. Information will be verified in the same natural way—left without “means of subsistence”, agents 20 delivering incorrect information will die out. On the other hand, in order to generate knowledge, agents 20 will not only struggle but also cooperate by creating the “trophic” information chains.

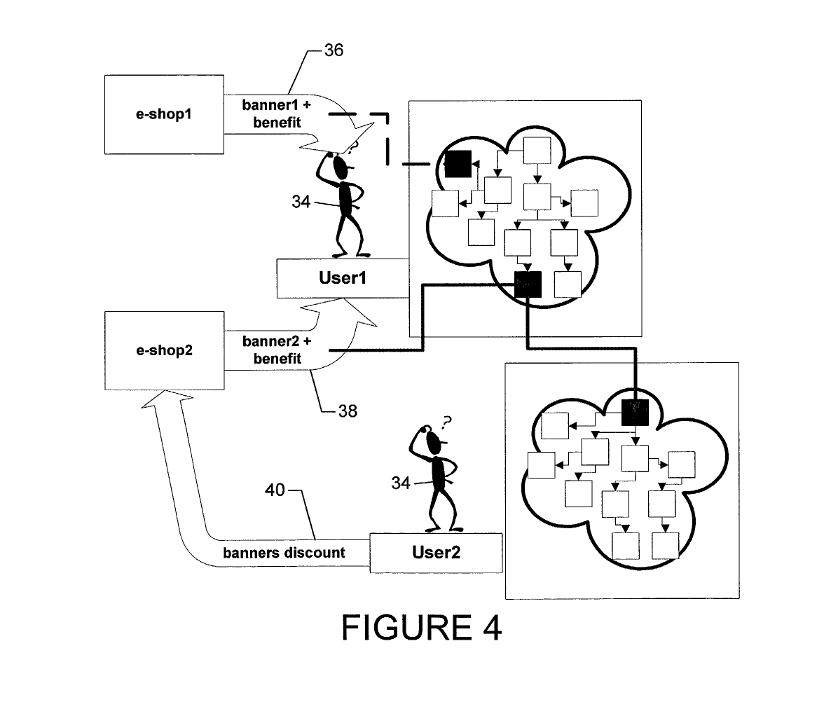

And, finally, agents 20 will make it possible to reorganize the existing ad system into a more efficient one, as shown in FIG. 4. Banners 36, 38 and 40 will be transferred to “discount coupons”, giving some benefits to its holders and distributors. While visiting the shopping site and making purchases or using another Internet resource, user 34 will take an ad banner or leave it. Taking the banners will mean economic preferences for the user (discounts, installments, etc.). Along with the other documents, the taken banner will be included into agent 20 of user 34. Answering the questions of the other users 34A who are subject-related to taken banner 40, agent 20 will make a chain transition of it to a person who is interested in such an ad. The same thing will happen when a new agent 20A will be cultivated on the basis of the part of the semantic hierarchy of this agent 20. Banner 38 will be also transferred to user 34 who is interested in this subject. Hence, advertising becomes targeted to the maximum extent, banners 36 and 38 become wanted when necessary and are never untimely. On the other hand, as the semantic space of agent 20 is hidden from the eyes of an outsider, no one can get information about the personal likes and habits of user 34. The semantic and hierarchical organization of this knowledge is also a part of this present invention, as disclosed below.

Internet 32 is a practically endless source of textual documents. In perspective, only the scaled and decentralized technology has a chance of survival. It is the technology that we should develop and offer to the network community.

The logic of development of Alter Ego products—transition from operating the ready databases to the self-organization of knowledge obtained in the Internet ocean—makes us review the basic scenarios of semantic categorization. While we spoke previously about one-off categorizations of the independent local collections of the end volume, today we, in addressing the challenge of scaleable mastering of Internet 32, are facing a dramatically new situation—categorization of the information available on Internet 32. It is obvious that the approaches to this challenge should be different in principle.

First, the global categorization of Internet 32 using one server and one semantic space proves to be impossible. Millions of network users should become involved in this process. Consequently, mass users need a convenient instrument. These should be agents 20, 20A . . . that are active in collecting the information on the relevant subject and adaptable (able to be reared by the user). The knowledge accumulated by such agents is concentrated both in semantic cartridges (local semantic spaces) and semantic index (a set of accumulated bookmarks submerged in this space). Let us assume that such an instrument is the Internet Analyst that can be renamed as Internet Agent.

Secondly, a convenient facility for sharing the obtained knowledge should be made available to the public. In fact, knowledge has always served as a commodity and the use of the unit “neuro” provides an appropriate infrastructure for the development of the knowledge sharing—a new, potentially capacious market of services. In other words, an individual agent 20 is important, not so much by itself, but in the context of a society of agents 20, 20A . . . that are capable of intercommunication. The difference between Internet Analyst taken separately and this new infrastructure is the same as the difference between the separate PCs and the Network. Consequently, along with the development of Internet Analyst, the present invention addresses the issue of creation of the relevant infrastructure—a network of cross-references of search agents which is similar to the network of hyperlinks in WWW.

In principle, any agent 20 is able to “register” itself in the semantic space of another agent 20A as soon as it has transferred to agent 20A a sufficiently detailed textual annotation of its index content. In fact, this is the way people communicate even though, in his mind, each person has a different idea about the meaning of the words. This detailed textual annotation of the index content of agent 20 will be a wormhole leading from the semantic space of agent 20A to the semantic space of agent 20. Then while making search in one semantic space it is possible to readdress the query to another semantic space etc. This is the way to open up an opportunity of creation and gradual development of the distributed collective intellect of the Network, which will gradually become aware of the inherent Network laws in the course of the ongoing categorization process (A kind of new “phenomenology of spirit”).

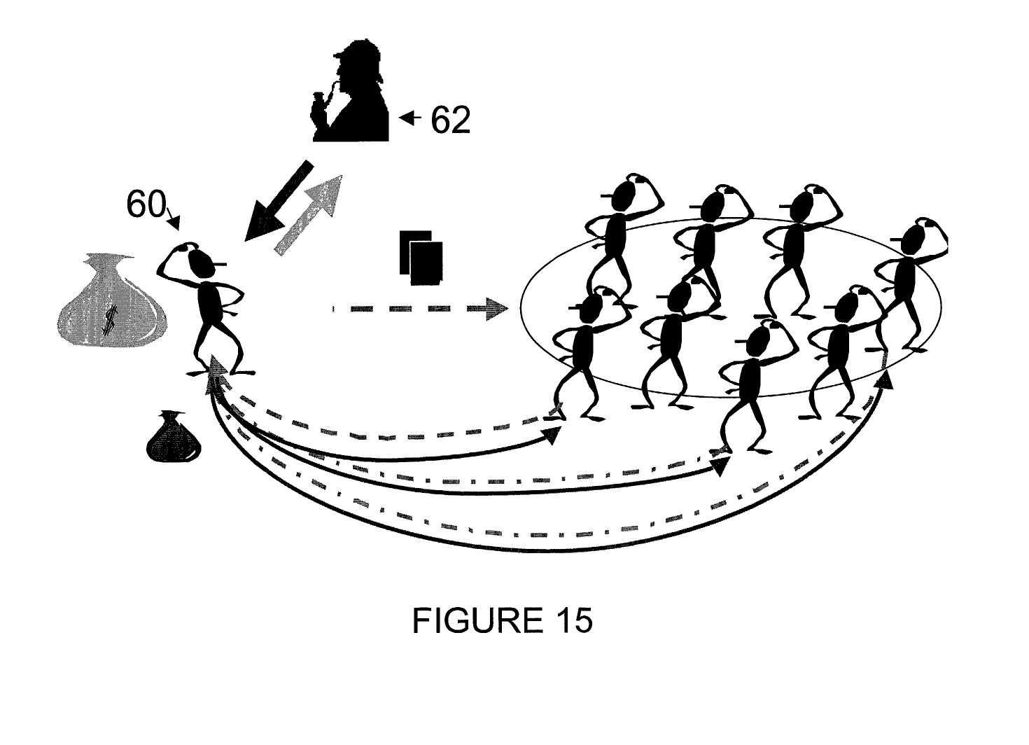

In order to implement the present invention, a central entity, such as NeurOK (see FIG. 15), creates a special site for the elaboration and demonstration of the new technology capabilities—distributed semantic indexing of Internet with the semantic indexing done by “all together”. As this model proves viable, it spreads over the whole Network in the same way it happened with respect to the WWW in its time. In this case, the centralized unspecialized searchers will be replaced by collection of information on the selected subjects. In order to launch such an avalanche-like, self-supporting process this site should have several desirable qualities.

Initially, this site should be useful. The people should refer to it for the solution of their real routine tasks. Only in this case we can hope to unwind the mass technology. As the present invention is engaged in search technologies, this site should be also a search site.

The site should also be not boring. Creating something new should be interesting and amusing. The site should encourage the occasional passers-by to become active participants rather than passive viewers. Obviously, it requires a bit of the game.

The site should also be self-developing. As long as a sufficient number of people are not involved in the game, it should play by itself and act as a kind of demo usually equipping the computer games. To “play” with a growing network of search agents, the site should demonstrate, as “bait,” a self-developing network of the search agents that index the Internet.

In other words, the new site creates a virtual world that evolves according to its own laws, that is populated by the search agents capable of providing the real information services to the users and that gives everyone a chance to become involved in this world by means of domestication or rearing of the wild agents.

As the evolution is always a struggle for the limited resources with a long- term view of the prospective Internet-economy, agents 20, 20A . . . can be made to earn money, (at the beginning, virtual money such as the “neuro”), by providing the real information services. This is the way to achieve natural selection and selection of the best search agents and make the lives of their owners more attractive by giving them a chance to make money using their “own brains”. Strictly speaking, the enrichment instinct underlies many games, such as, for example, the Capital, as well as business as such. Let us look at the principles underlying the self-developing search site—a prototype of the growing search network of semantic agents.

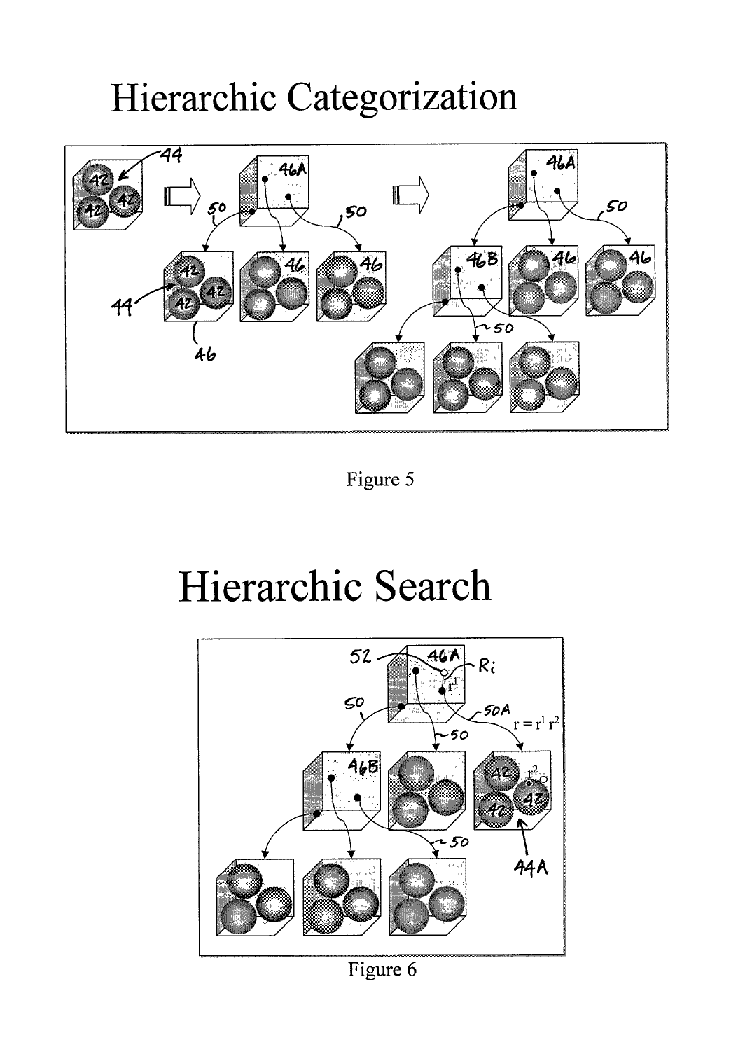

From the very beginning, the approach suggested rejects an idea of creation of the global semantic space and follows the road of search based on the references between the local semantic spaces. The inducement for the search semantic network can be created using the hierarchic categorization procedure illustrated in FIG. 5 that is somehow similar to the hierarchic clusterization procedure in SE2. To get a clear view of what it is, consider an idealized statement of a problem leaving out the Internet and information extraction for the time being.

Imagine the problem of categorization of the endless document collection that has been organized in such a way as to give an inflow of the new documents. Instead of one comprehensive set of semantic categories, build up a hierarchy of the local semantic spaces. Assume that an N number of documents 42 per cluster 44 are required for the set categorization accuracy, i.e., NK documents 42 for the categorization in the K-d semantic space (because each category constitutes a cluster 44 of documents 42). In principle, the K-d semantic space 46 can organize its own internal hierarchy of clusters 44 used for the visualization as in the case of SE2. Practicability of such a complication, i.e. compatibility of the two hierarchies, needs a separate consideration. Considering the simplest case, the categories make the only clusterization level while the hierarchy is achieved due to the embedded semantic spaces 46.

Select ˜NK optional documents 42 out of the endless collection and build up semantic space 46A of the upper layer of our hierarchy. The incoming new documents will be indexed in space 46A and made available for the semantic search. This will continue until our semantic index accumulates ˜NK2 documents. Such semantic space is mature enough to become divided. One should complete an adaptation of the categories using all the available documents before the division because after that no opportunity will be provided to upgrade the semantic categories of this space. After that the initial space 46A becomes divided—all the documents are distributed between the K clusters 44 each holding ˜NK documents 42. Each sub-collection of this type is used to build up its own local semantic subspace. The parental space 46A remains only with wormholes 50 leading to those subspaces—centroids of cluster-categories. Now instead of one server, there are K+1 servers that intercommunicate downward. Each server is logically independent and designed in the same way.

Further things develop as follows. The incoming documents become submerged in the upper level space 46A with the subsequent distribution among the subspaces 46 through the nearest wormhole 50. Having received the document from the upper level 46A the next level server 46B submerges it in its space and indexes. This continues until server 46B of the lower level grows up to its division point having accumulated a sufficient number of the documents. After that the next hierarchy level is formed. The leaves of the growing tree are the documents stored in the subspaces of the lower hierarchic level, as shown in FIG. 5.

As the documents from the outside world become accumulated, there grows a hierarchy of semantic spaces “learning” the Internet and allowing an associative search in the above-mentioned way, as shown in FIG. 6. Because the servers intercommunicate using TCP-IP protocol, i.e. transfer of the documents for indexing or search queries, they, in principle, can be installed on different machines, including user machines. This is the way to reach the required scalable technology of semantic indexing of the Internet.

Such a continuously growing hierarchy of semantic spaces has a downward search, as shown in FIG. 6. The upper level server 46A receives a search query and re-addresses it to the relevant lower level server 46. This continues to the point of document references. While the indexation distributed all the documents between the lower level servers “by force” (through the nearest wormholes 50 in the upper level subspaces), the search makes such rigor unnecessary. If, say, the upper level 46A receives a search query for a certain number of the documents 42, such query can be split into several queries to the servers 46 with the nearest wormholes 50. The number of documents 42 in each sub-query will be proportional to the relevance of the corresponding wormhole 50. This is the way in which we partially compensate an absence of the single semantic space and related weaknesses of the hierarchic search. Hence, the built-up hierarchy can be interpreted in terms of the inaccurate logic.

From this standpoint one can determine the query relevance, for example:

$${r}_{i} = \frac{{σ}_{i}^{2}}{{σ}_{i}^{2} + {R}_{i}^{2}}$$

in which Ri is the distance between query 52 and wormhole 50A and σi is the radius of attraction equal to the radius of the corresponding cluster before the division process.

If this relevance is interpreted as the probability of belonging to the given wormhole 50A, it would be logical to define the document relevance to query 52 as a product of all the relevancies on the way to the document:

r=rᵢ¹ . . . rⱼⁿ.

At the last n-level Ri should be understood as the distance between the document 42 and query 52, while σi would be the radius of the document- containing cluster 44A.

The specific algorithm of the query distribution between the lower level servers would be in some way based on the wormhole relevance while the total relevance of the documents in the query would be calculated using the above formula. Information filtering is based on the set individual profile. Let us see how we can set the user profiles (or a specific column in the personal newspaper) within the framework of the growing hierarchy of semantic spaces.

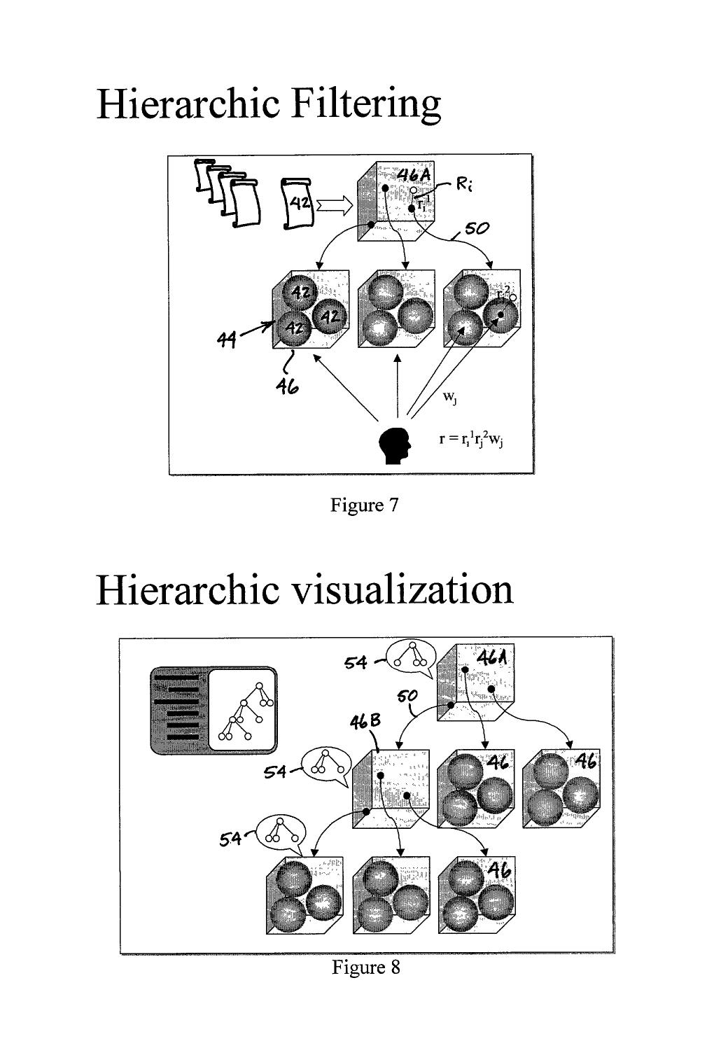

In the information-filtering context the semantic space clusters can be interpreted as reporters. Then the interest profile can be set by means of the weights connecting each reporter to the profile, as shown in FIG. 7. The profile is adapted in a normal way: the weight of the reporter bringing the relevant document increases while the weight of the reporter bringing the irrelevant document goes down. After each bonus/punishment the weights are assigned a different norm.

In principle, two profile models are possible. The first, a more general model, allows the clusters as reporters at any hierarchy level. Conversely, in the second model only the clusters at the lowest level clusters can act as reporters. The first model is more compact while the second one allows a more accurate adjustment to the user's interest. If the lowest level cluster becomes divided, the second model weight of all its descendants should anticipate a parent of the same weight. After that the scales are assigned a different norm.

In any case ranking of all the incoming documents is a product of the ranking of the document for the given reporter and the reporter's ranking for the given profile

r=rᵢ¹ . . . rⱼⁿwⱼ.

The documents for each column of the personal newspaper are selected based on the rating. Visualization of the hierarchically categorized document collection can be built up on the basis of Summon's maps just as in the case of hierarchic clustering, as shown in FIG. 8. Each server builds its own visualization cartridge containing Summon's maps 54 of its wormholes 50 plus their annotation. Each cartridge is included into the cartridge of its parent either in the form of data or in the form of reference. Depending on the level of detailed visualization the card hierarchy is shown only partly. Loading of the displayed parts can take place in dynamics.

All the above said testifies to the fact that in principle, the hierarchic semantic analysis can be performed without the hierarchic clustering serving as a basis for SE2. Although these two approaches are not contradictory, it hardly makes sense to implement both of them because that would make the products more complicated without any justification. The preference is to have the whole Alter Ego line based on the single architectural principle. Selection of architecture implies a detailed comparison of the two approaches.

The Strengths of Hierarchic Categorization can be viewed as several facets. There are basic units—categorizer and server—operating only one cluster set becomes simplified to the utmost level. The semantic cartridge contains only the matrix of categories and cluster centroids agreed during the categorization process. The visualization cartridge also becomes simpler because each server has a one-level cartridge. Search and indexing can be made parallel and distributed over the Network. Growth of the distributed semantic index is not limited to one semantic space. The semantics gets richer with the adaptation of new semantic spaces and the new information keeps the old one intact. Architecture allows an organic inclusion of the adaptable personal agents being the same semantic spaces through the same wormholes involved in the organization of semantic hierarchy. Thus the network can grow not only downward but also “laterally”. There is some hope that the search quality will improve because for each subspace all the word-forms will have their own information ratings rather than single ratings for the whole collection.

There are also weaknesses of Hierarchic Categorization. Generally speaking, search and visualization will be slower as they require the information transmission between the servers. Both indexing and search imply a multiple submersion of the same document into different semantic spaces. The visualization process may slow down during the loading of relevant cartridges from the other servers.

In general, it appears that the strengths of hierarchic categorization offset its weaknesses by far. This principle can well be a basis for the self-developing search site serving both for the search and personal information filtering. All the NeurOK products can be assembled using quite simple cubes—Semantic Cells (SC=categorizer+indexer+crawler) initiating each other recursively. The same cubes can become building material for the distributed semantic indexing of Internet by the whole network community.

So far, how the new documents get to the site has not specified. The single or multi-flow crawler picking the documents at random could organize this flow, for example. In this case, the site would gradually develop into the global associative search of information about everything. However, the objective lies far from creating one more searcher, even a better one. The site is created for an absolutely different purpose, i.e. initiating the new technology of distributed Network indexing which “kills” the very idea of centralized searchers.

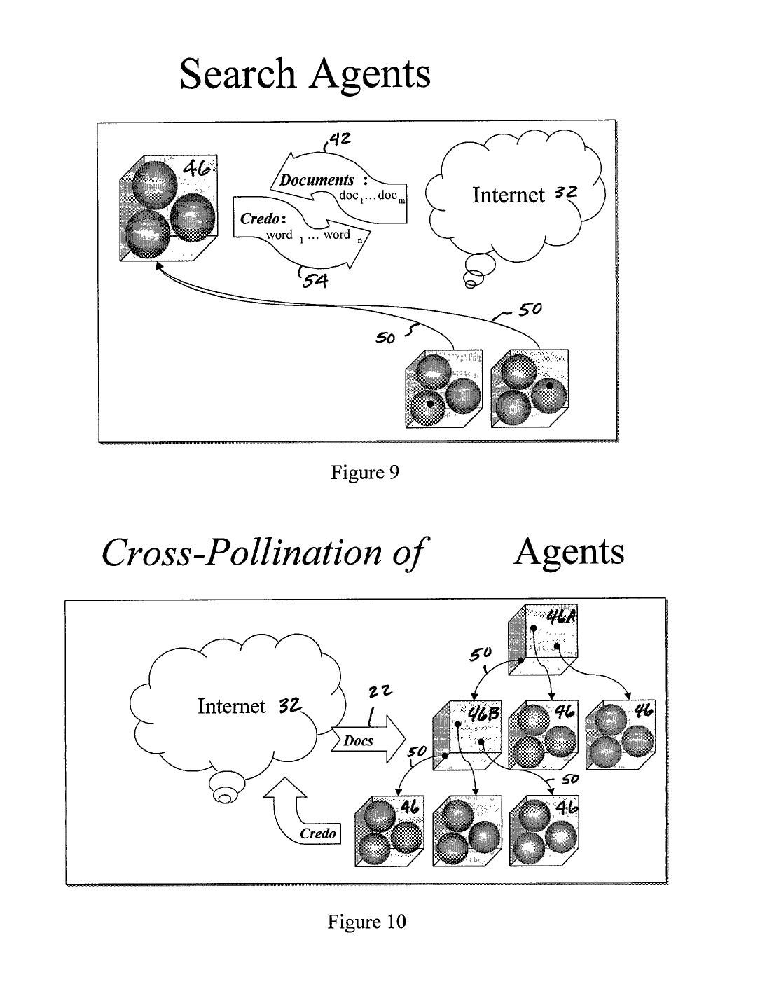

The Search Site is an Ecosystem of Agents. For this reason this site should be based on the technology of search agents operating in the Network independently but capable, if necessary, of bringing their efforts together, as shown in FIG. 9. The semantic servers 46 each operating in its own space constitute independent basic units in the above-mentioned scheme of hierarchic categorization. It would be logical to build up the search agents based on those semantic servers 46. If each of them is equipped with a crawler 22 delivering the new documents we should be arriving at the self-sufficient self-developing search system based on the interacting semantic cells.

As we are interested about the basic principles of organization of the distributed agent search, we will not specify the operating mechanism of such crawler. It would be enough to assume that based on its credo 54, which is a textual summary of its search objective, such crawler is able to extract from the Network the required documents of similar content. The crawler's credo 54 consists of a set of the annotating terms which can be used both for the normal key search (for example, by contacting the normal search servers) and for the associative search by means of the other agents (registering their wormholes 50 in their semantic spaces).

In particular, the above-mentioned hierarchy of semantic searchers automatically organizes such wormholes 50 (towards its parent). The credo 54 as a set of words annotating the parent word cluster is also formed automatically in generating a new server.

One of the ways of cell interaction in the hierarchic architecture to be suggested sounds as follows: the crawler 22 of each cell extracts from the network the semantically adjacent documents, as shown in FIG. 10. The documents obtained by means of key search are channeled for indexing to the crawler's parent space 46B, if possible, (option: grandfathers space 46A, etc. up to the upper hierarchy level) rather than its own semantic space 46. The parent's space 46B provides a more accurate semantic filtering forwarding the obtained documents to a more suitable offspring 46. This is how the cells cooperate performing cross-pollination: the obtained documents do not disappear even if their subject matter does not coincide with subject-matter of a particular cell.

Thus, the self-organizing hierarchy of servers can be treated as a natural evolution of the ecosystem of the interacting unicellular organisms organized into the trophic network of the associative information processing. However, it is important that along with the natural evolution the same agents can be used for the targeted selection of particular agents in the interests of particular users and their association into the effective search networks in the interests of the whole Network community.

A product with a yet conventional name of Internet Agent will serve as a tool of targeted selection or rearing of the search agents by the users. In fact, a multicellular agent, the growing hierarchy of semantic cells, will be a subject of rearing. In addition, Internet Analyst will be able to use the services of the like agents contacted with whom it has registered its wormholes. In particular, the hierarchy of semantic cells reared on the site may become one of such partners. Actually, at the beginning the Internet Analyst users will not have so much choice, because it is the very site that will set the game rules and provide the required infrastructure. In particular, the Internet Analysts themselves are likely to be distributed from this site.

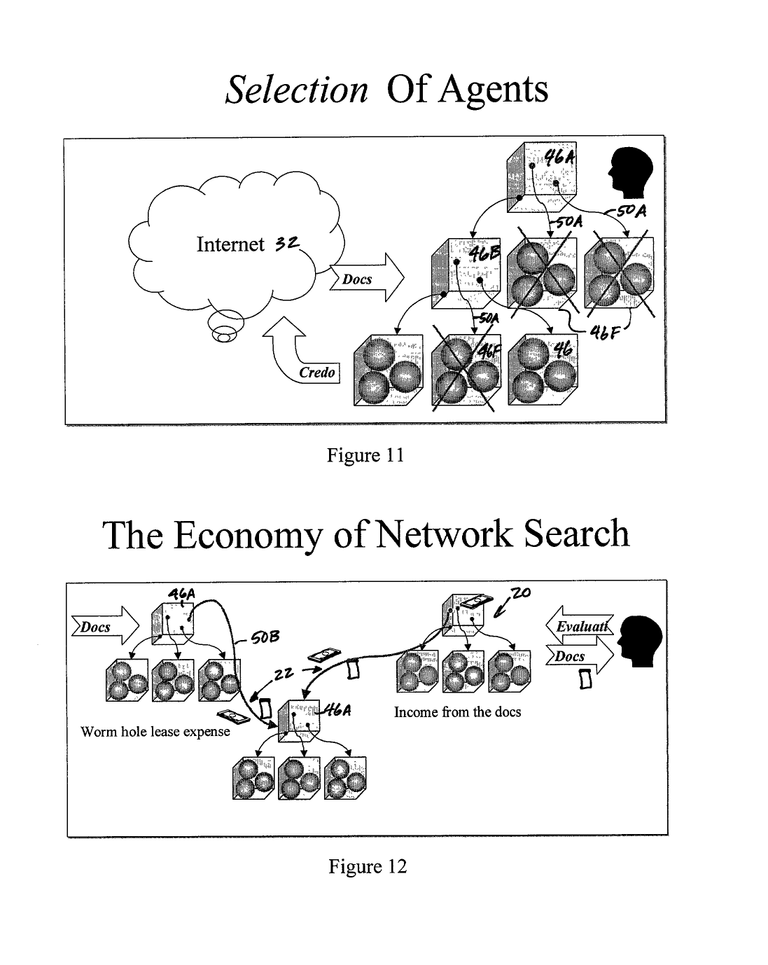

The user will be provided with the necessary tools of “coaching” his personal Internet Analyst for the selected subject. For example, in analyzing the visual presentation of his index he will be able to cut off those branches of the evolution tree that he thinks unnecessary. The wormholes 50A of the discarded cells 46F will be marked as irrelevant, and the documents not pertaining to the issue concerned will be “disappearing” there, as shown in FIG. 11.

In addition, the user will be able to manually edit credo 54 of semantic cells 46 of his Internet Analyst thus having an impact on the key search and making its content more available for the other users of his Internet Analyst.

Gradually, in the process of targeted selection of this type the agent will, firstly, acquire his own unique hierarchic semantic profile, and, secondly, gather the relevant annotated base of references to the resources that he considers the most valuable. Such agent 20 can provide search services to the other Internet users. As agent 20 use the services of other agents 20A, 20B, . . . , in creating their own index and profile, the exchange of services can become a basis for a kind of economy of search services. This economy should be organized so as to increase the integral efficiency of the search network of the whole agent community.

The goal of any economic entity is the accumulation of capital. The capital is expressed not only and not so much in money terms. Capital is the value capable of self-reproduction. For the search agents providing search services, capital accumulation means accumulation of the ability to serve search queries.

The consumers of search services—the users of search semantic network—are always the source of money. Any useful document received via the semantic network is income earning. If virtual money (e.g., a “neuro”) is introduced to the Neurok site, the issuing center will be the site users who have approved the found documents. Hence, the total amount of money in the economy will be a usefulness measure of the whole search site. It can be shown during the visit.

How is this money allocated between the economy participants? First of all, the participants must be determined. Firstly, it is the self-developing site, also a kind of agent that is initially the only economic entity. Secondly, there are search agents created by the game players who decided to join the growing semantic network. The agents distribute the network profit among themselves in proportion to their input into the surplus value.

The agent directly addressed by the search query receives for the found documents a certain amount proportional to the number of the found documents with scales that depend on the usefulness of such documents as evaluated by the users. Since the search contains a number of the requested documents, the quantities only do not bring any earnings. (It is implied here that the interface with the user makes it possible to receive a corresponding response from him). If, in searching these documents, the agent used the services of another agent, i.e., received the required documents from it, that sum less the commission would be transferred to this second agent. Thus, using this chain the money gets to the source whose semantic index stored the useful document. Hence, the agent's source of income can be (a) commission fees for showing the right way to the required document and (b) fees for storing in the index the references to the valuable documents. Generally speaking, these two sources are virtually the same: fees for the index of the valuable information.

Next is the determination of how the money received by agent 20 is spent. Naturally, this money goes towards the accrual of capital, i.e., the ability to earn money. Consequently, the money is spent on the increase of the quantity and quality of the available references—both to the documents and other agents. Inflow of the new documents into its semantic index can happen either due the scanning of the network by means of its crawlers (this is a source of its surplus value) or through the subscription from the other agent's crawlers 22 where the agent has set up its worm hole 50 B, as shown in FIG. 12.

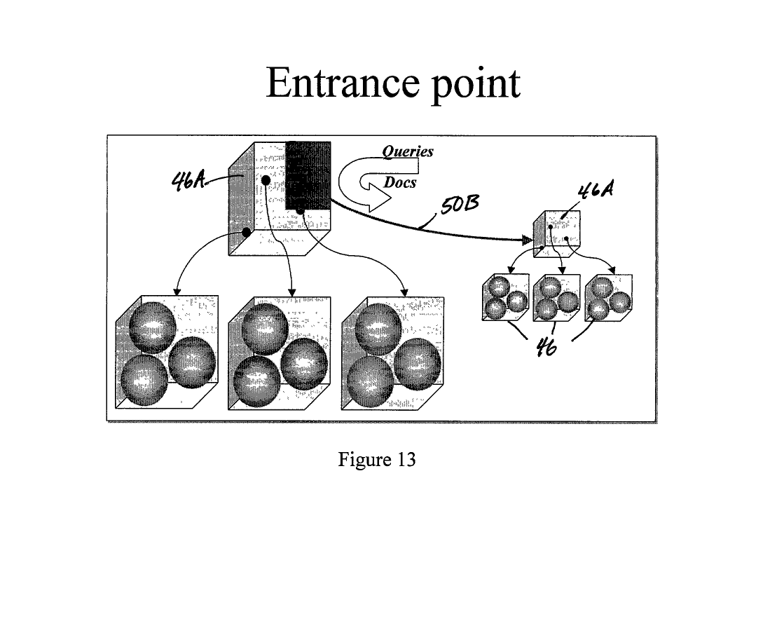

The new documents and the corresponding search queries travel via the wormhole connecting two agents. Both documents and search queries increase the probability of getting the money, as shown in FIG. 13.

Thus, for installation of a wormhole 50B of one's own, it is necessary to pay a certain lease payment. The condition of reaching balance in economy is an adequate compensating of average lease payment by profits. At that, it ought to be performed automatically. Actually, the result of installing to yourself somebody's input point is that the documents found in the Net would go to alien index field, i.e. some profit would be lost without any doubt and thus become subject to compensation. On the other hand, each separately taken agent 20 has in its disposal a limited volume of computing resources, and that fact stimulates him to originate wormholes 50 to other agents 20, 20A, . . . . The lease payment for a wormhole provides to the donor—agent a kind of permanent source of income, independent of the availability of search queries. Besides, he receives the commission payment, when the queries are re-transmitted to the recipient—donor through his wormhole. If the connection were successful it would bring mutual profit.

The agent should maximize his profit, i.e. be bent on installing his wormhole in the optimal way—in order to grant the maximal flow of relevant documents and queries to them.

If the connection is limited, for example, being specialized in sport, he would install his wormhole in the cell devoted to art, then both the flow of documents about art and the flow of the corresponding queries would stream to him. Meanwhile, his semantic field, not intended for search of this type of documents, would process the queries rather poorly, which would tell on his incomes.

The agent should regulate somehow installation of his wormholes, for the sake of maximizing his income. The natural criterion for appraising effectiveness of each of those connections is its profitability. Let us assume that agent 20 in the process of installing his wormhole 50, he evaluates it and the wormhole is proclaimed to be unproductive. Then, agent 20 tries to find more optimal disposition for it in the semantic net. The search of the semantic meshes, suitable for installation of wormholes can be based on queries, formed on the ground of one's own credo. This simple and economical algorithm will provide for the community of agents the opportunity of self-learning, responding to the reaction of the users.

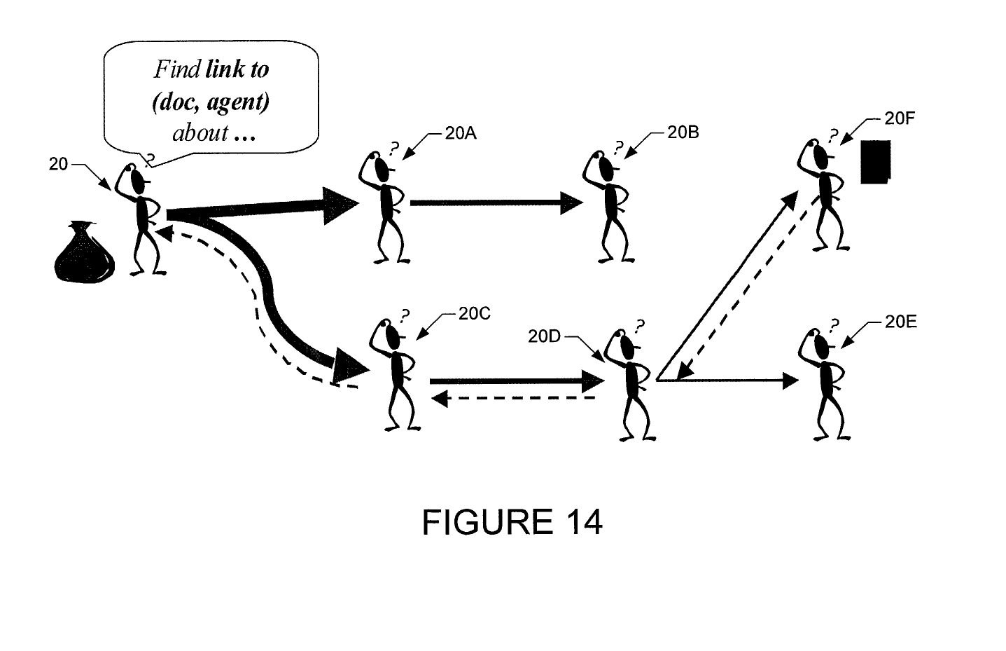

A preferred embodiment of the present invention is as a peer-to-peer knowledge network with a currency-based protocol. As shown in FIG. 14, data sharing is provided by each agent by either answering or redirecting a query. Each query costs neuros and mediators can earn money. A minimal cost, of perhaps 1 neuro per query, helps to limit query expansion. By having agents 20A, 20C and 20D ask for links to other agents, the links can vary based on the query. Links to successful agents will strengthen, leading to self-optimization.

Various advertisement models can be incorporated into the peer-to-peer knowledge network. In a branding model shown in FIG. 15, advertisers 60 purchase neuro from NeurOK 62 with real money. This money increases the money reserve for neuro emission. Then, the advertisers put their banners into the knowledge network. Each click on a banner earns a neuro for the associated user's agent.

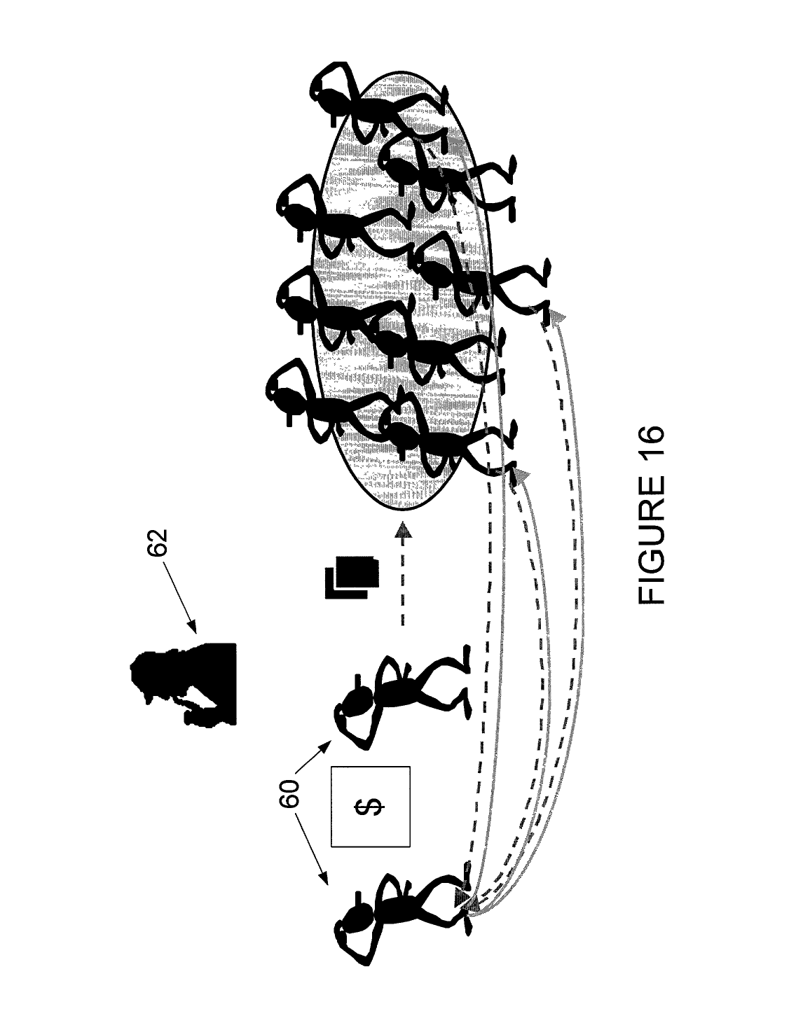

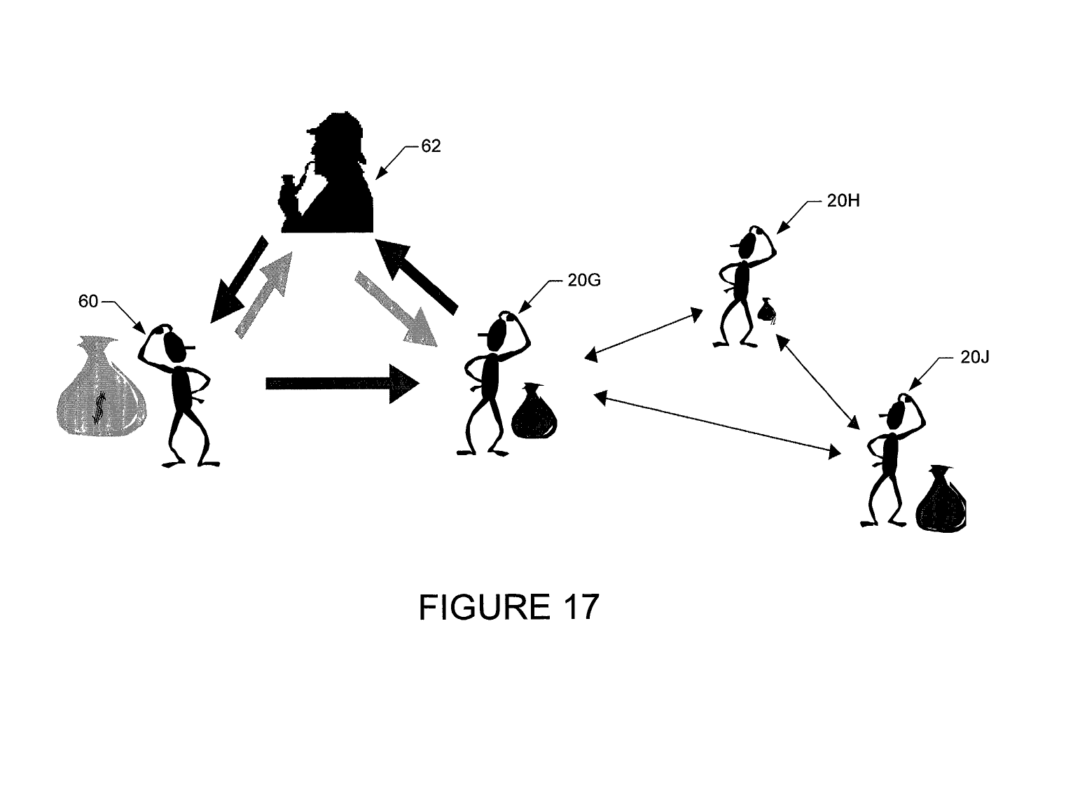

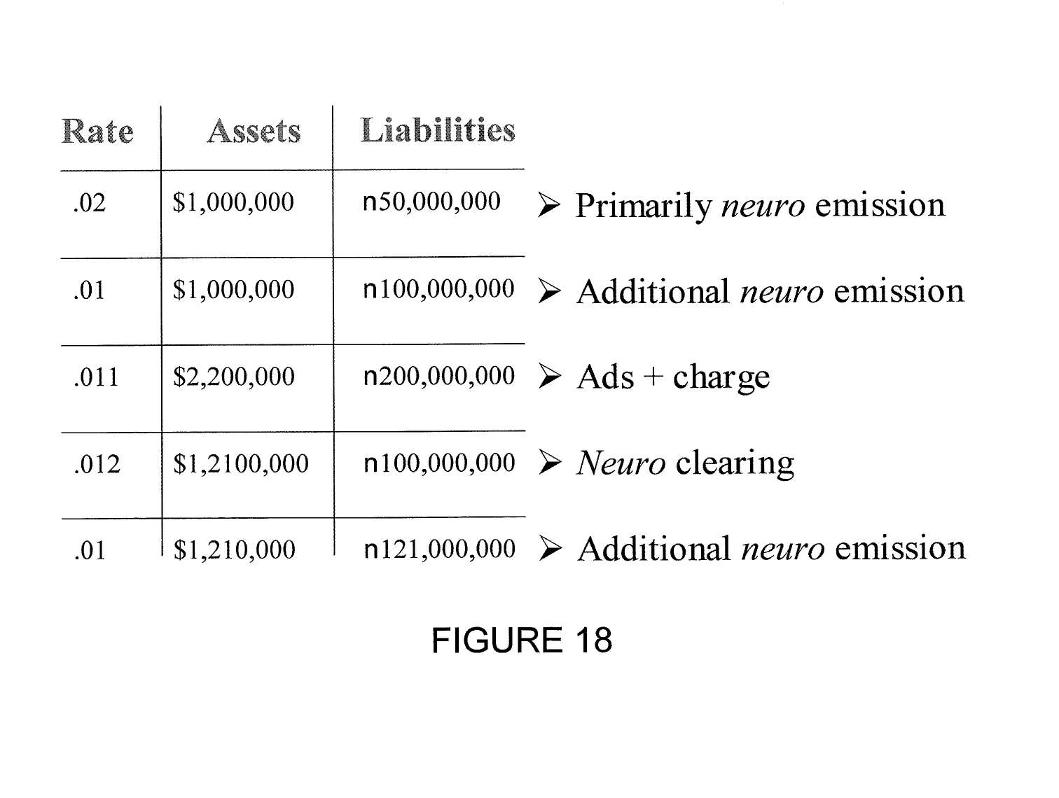

As illustrated in FIG. 16, for e-commerce advertisers, the banners can be countdown coupons that link to the advertiser's e-shop, so when a user visits the e-shop by clicking on the banner, the user can take advantage of a real (i.e., actual money, not a neuro) discount that is greater than the neuro(s) spent by the user for clicking on the banner. This difference between the discount and the spent neuro to obtain the discount results in a net value for the user. The common attribute of any of these business models is that an entity, such as NeurOK, acts as a clearinghouse. As shown in FIG. 17, NeurOK 62 emits, quotes, and exchanges neuro. As each neuro has an equivalent monetary value, successful agents 20G, 20H and 20J can earn money. Advertisers 60 and net information users pay when they want to change neuro to real money or vice versa. NeurOK 62 generates revenues, such as through a commission fee from the neuro exchanges to real money and back for users and advertisers. A typical financial scenario of this is illustrated in FIG. 18.

In summary, the present invention is based on neural network technology, wherein agents employed by each peer in a peer-to-peer Knowledge Network can understand the content of any document in the network (whether an ad banner or another Agent). Agents can learn from any information, user preference and query. The Agents themselves create the Knowledge Network by connecting to each other (peer-to-peer). In order to facilitate the exchange of information between peers in the peer-to-peer Knowledge Network, a facilitating entity, such as NeurOK, creates, emits, and quotes an internal currency, such as a neuro, and provides a central banking and/or clearinghouse function.

Agents pay neuro to each other for information, answers, documents, banners, and link to another agents. The minimal costs involved restricts the overall distribution of queries. For example, if an Agent has received only one neuro in order to provide an answer to a query, it cannot ask any more Agents. Useful links (i.e. links to useful Agents) become stronger and successful Agents earn neuro.

To aid in answering queries, each Agent includes: a context for each document, ad banners, linked agent. Each agent also includes a rating of each document, ad banners, linked agent. All neuro transfers exist between Agents. If it is necessary to exchange the neuro to real money, NeurOK redeems the neuro and returns real money.

NeurOK earns revenue though a commission on the neuro exchange, but doesn't make any commissions from any exchanges within the Knowledge Network. This Knowledge Network maintains new possibilities for ad distribution, branding, and countdown (discount) trading. Thus, network marketing principles are realized through the peer-to-peer ad distribution.

While the present invention has been illustrated by way of preferred embodiment, it is to be understood that the scope of the present invention is not to be limited thereto, but only by the scope of the following claims.

1. An electronic agent for a user comprising:
server member for providing information concerning the user;
categorizer for creating hierarchic semantic space; and
crawler members for performing directed information searches.

2. The electronic agent according to claim 1 wherein said server member includes:
FTP server to provide information on the basis of TCP/IP protocol.

3. The electronic agent according to claim 1 wherein said server member includes:
Web server to provide access to information of the user on the basis of hyperlinks.

4. The electronic agent according to claim 1 wherein said server member includes:
Internet se mantic server for indexing new information in said hierarchic semantic space.

5. The electronic agent according to claim 4 wherein said Internet semantic server includes:
means for providing responses to queries of clients.

6. The electronic agent according to claim 1 wherein said crawler member includes:
means for arranging results of said directed information searches; and
means for delivering results of said directed information searches to users.

7. A method for a user to communicate information on the Internet comprising:
exchanging information through a server;
performing directed information searches on the Internet; and
creating a hierarchic semantic space.

8. The method for a user to communicate information on the Internet according to claim 7 wherein said exchanging includes:
providing information relating to the user on the basis of TCP/IP protocol.

9. The method for a user to communicate information on the Internet according to claim 7 wherein said exchanging includes:
providing access to information of the user through hyperlinks.

10. The method for a user to communicate information on the Internet according to claim 7 wherein said exchanging includes:
indexing new information in said hierarchic semantic space.

11. The method for a user to communicate information on the Internet according to claim 10 wherein said indexing includes:
generating responses to queries of clients.

12. An electronic agent for a user comprising:
server member for providing information concerning the user, said server member including an FTP server to provide information on the basis of TCP/IP protocol, a web server to provide access to information of the user on the basis of hyperlinks and an Internet semantic server for indexing new information in said hierarchic semantic space and for providing responses to queries of clients;
categorizer for creating hierarchic semantic space; and
crawler members for performing searches having means for arranging results of said directed information searches and means for delivering results of said directed information searches to users.

13. A network system for exchanging information comprising:
providing a plurality of neurocomputers, each neurocomputer being an agent associated with a user;
linking said plurality of neurocomputers;
accumulating knowledge by each of said agent according to preferences by said user associated with said agent, said knowledge for answering queries; and
exchanging monetary value between said plurality of agents for answering queries and referring queries.

14. The network system according to claim 13 also including:
generating banners by advertisers for insertion into the network system.

15. The network according to claim 14 wherein said accumulating knowledge includes:
collecting documents relating to said preferences of said user.

16. The network system according to claim 15 wherein said accumulating knowledge includes:
obtaining context for each documents, banner and linked agent.

17. The network system according to claim 16 wherein said accumulating knowledge includes;
maintaining a rating for each document, banner and linked agent.
